(19) United States
(12) Patent Application Publication
(10) Pub. No.: US 2022/0037737 A1
(43) Pub. Date: Feb. 3, 2022

(54) BATTERY SYSTEM AND MOTOR VEHICLE HAVING A BATTERY SYSTEM

(71) Applicant: AUDI AG, Ingolstadt (DE)

(72) Inventor: Marvin CZECH, Ingolstadt (DE)

(73) Assignee: AUDI AG, Ingolstadt (DE)

(21) Appl. No.: 17/385,197

(22) Filed: Jul. 26, 2021

(30) Foreign Application Priority Data
Jul. 29, 2020 (DE) 10 2020 120 041.2

(51) Int. Cl. H01M 50/383; H01M 50/342

(52) U.S. Cl. CPC H01M 50/383; H01M 50/3425

(57) ABSTRACT

A battery system, including a plurality of battery cells arranged in a battery housing. A cell housing of a respective battery cell and/or the battery housing have/has at least one degassing opening through which a stream of gas can escape along a predetermined degassing path into the surroundings of the battery cell and/or the battery system. A spark arrester prevents sparks and/or particles from being released into the surroundings together with the stream of gas and from igniting said stream of gas there. The spark arrester also acts as a heat exchanger for the stream of gas. It is designed to slow down the stream of gas and to direct it along a surface of the spark arrester such that it flows along the surface for at least a predetermined period of time.

### FIELD

The disclosure relates to a battery system, and a motor vehicle having a battery system.

### BACKGROUND

A battery system for the purposes of the present disclosure comprises a plurality of individual battery cells which are arranged in a battery housing of the battery system. A respective battery cell can be designed as a pouch cell, as a prismatic cell, or as a round cell. Known battery cells of the type mentioned comprise a galvanic cell, wherein said galvanic cell has an anode and a cathode, which can be electrically insulated from each other by a separator or a separator film and arranged to form a cell coil. The cell coil described is enclosed by a cell housing of the respective battery cell and embedded in an electrolyte or an electrolyte solution. Such a battery cell can provide an electric voltage between 3 and 5 volts, in particular between 3.5 and 4.5 volts. The plurality of battery cells of such a battery system can be electrically connected in series and/or in parallel in such a way that electric voltages and currents can be provided, which are suitable to provide an electric driving power for an at least partially electrically powered motor vehicle.

It is known that a cell defect within the galvanic cell or an aging process within the galvanic cell can lead to gas formation in an interior of the respective cell housing. To relieve cell pressure that has been increased by the formation of gas, known cell housings and/or battery housings have degassing openings or rupture openings through which the gas can be released into the surroundings of the battery cell and/or the battery system. Depending on the cell chemistry prevailing in the galvanic cell in question, the gas can be more flammable than ambient air. In addition, the cell chemistry has an impact on the temperature of the gas. Depending on the cell chemistry, gas temperatures can reach up to 1500 degrees Celsius.

In order to prevent such a gas from igniting by a flame entering the cell housing and/or the battery housing from outside, GB 1355831 and WO 2013/128226 A1 each propose flame arresters.

The ignition of the gas by flames entering the cell housing from outside is not the only problem, however. As is well-known, it can happen that particles and/or sparks are entrained in the gas formed. If such a stream of gas that is loaded with particles and/or sparks, comes into contact with ambient air that is enriched in oxygen relative to the ambience of a battery or the ambience in the interior of the battery, the stream of gas can be ignited by the sparks entrained. To resolve this issue, EP 2 849 257 A1 discloses a spark arrester arranged at a degassing opening for filtering out the sparks from the stream of gas. The disadvantage here is, that, even though the stream of gas, after passing through the spark arrester, may no longer contain sparks and/or particles, it usually will still have a temperature, which is potentially sufficient for a spontaneous self-ignition of the stream of gas in contact with the oxygen-enriched ambient air.

### SUMMARY

The disclosure is based on the object of further increasing the operational reliability of a battery system of the type described above in the event of a gas leak.

The disclosure provides a battery system having a plurality of battery cells arranged in a battery housing. A respective battery cell has a cell housing at least partly surrounding a galvanic cell. In other words, a respective battery cell comprises at least one galvanic cell, said galvanic cell being at least partly surrounded by a cell housing. The battery cell may be a pouch cell, a prismatic cell or a round cell. The cell housing and/or the battery housing of the battery system have/has at least one degassing opening, which is designed to let a stream of gas escape from an interior of the cell housing and/or the battery housing along a predetermined degassing path into the surroundings of the battery cell and/or the surroundings of the battery system. In other words, the cell housing of a respective battery cell and/or the battery housing of the battery system provides a mechanical and/or structural and/or material weak spot, which, in the event of a gas formation as described above, lets the gas escape in a defined or predetermined manner. In the event that the degassing opening is arranged in a housing wall of the cell housing, the stream of gas will therefore initially escape from the battery cell into an interior of the battery housing. If the battery housing also has at least one such degassing opening, the gas discharged from the battery cell can be directed in the interior of the battery housing, in particular along a predetermined degassing path, to the at least one degassing opening of the battery housing and released through said degassing opening into the surroundings of the battery housing. A spark arrester, which is designed to filter out or hold back sparks and/or particles from the stream of gas, is arranged along the degassing path.

According to the disclosure, the spark arrester is designed to take on a heat exchange function in addition to the described filter function. In other words, the spark arrester is designed to act in the manner of a heat exchanger. For this purpose, the spark arrester is designed in such a way that it reduces a flow rate of the stream of gas compared to an initial rate and thus decelerates the stream of gas. In addition, the spark arrester directs the stream of gas along a surface of the spark arrester. This can be implemented by ducts along the surface, which on the one hand increase the surface and on the other hand exert a guiding or directing effect on the stream of gas. As a result of the deceleration, the stream of gas is held back within the spark arrester for a predetermined period of time, so that an exchange of heat between the stream of gas and the material of the spark arrester can take place. In other words, the spark arrester is designed to reduce a flow rate of the stream of gas and to direct the stream of gas along a surface of the spark arrester so that the stream of gas flows along the surface for at least a predetermined period of time.

According to the disclosure, the period of time, the surface, and the reduced flow rate are matched to one another such that thermal output energy is extracted from the stream of gas to the extent that a temperature of the gas when escaping into the surroundings has dropped to a value below a predetermined limit temperature value. In particular, there is freedom of design with regard to the design of the surface of the spark arrester. Depending on the choice of a geometric shape and/or material of the surface, an extraction of heat output of the surface in relation to the thermal energy of the stream of gas can be varied. If, for example, a highly heat conductive material is chosen for the surface, the period of time for which the stream of gas must flow along the surface, can be reduced. This provides for a high flexibility in terms of the best possible utilization of available installation space.

Therefore, according to the disclosure, a heat exchange via the surface of the spark arrester and/or by the length of the flow path takes place within the spark arrester. As a result, in an advantageous manner, the stream of gas in contact with the ambient air has reduced its temperature in such a way that self-ignition of the gas is prevented. An active control of the heat exchange is not needed because the spark arrester can be dimensioned as a function of a self-ignition temperature of a potentially leaking gas. It can therefore be dispensed with, to perform a temperature measurement of the gas before it is released into the surroundings, since it is ensured by the design of the spark arrester that the gas when escaping into the surroundings is or has been cooled to a value below its respective self-ignition temperature. This has the advantage that the entire heat exchanger system can be operated reliably and with particularly little wear.

The disclosure also includes embodiments providing additional benefits.

One embodiment provides that the galvanic cell has an electrolyte having a predetermined chemical composition, wherein the predetermined limit temperature value is a function of at least one cell-chemical parameter of the chemical composition. The chemical composition can, for example, describe a ratio of nickel:manganese:cobalt. The ratio can be 8:1:1, for example. Depending on the ratio of said mass fractions of the elements, a different self-ignition temperature may result for a stream of gas degassing from such a galvanic cell. Depending on the electrolyte used, there may be a different limit temperature value, wherein the design of the spark arrester with heat exchanger function ensures that the stream of gas, when escaping into the surroundings of the battery system, is below the respective limit temperature value.

A further embodiment provides that the spark arrester has, at least in some areas, a sponge structure with an open pore space, wherein the open pore space of the sponge structure is designed to be traversed by the stream of gas. This means that the spark arrester can be formed at least in some areas by a foamed material, such as, for example, foamed glass. In particular, ceramic and/or glass-ceramic materials can be foamed in such a way that they provide an open pore space which can be traversed by the stream of gas. Advantageously, this results in a particularly simple production of the spark arrester.

According to a further embodiment, the spark arrester has, at least in some areas, a fabric made of a glass fiber-based and/or ceramic material.

Alternatively or additionally, the spark arrester can, at least in some areas, have directional and/or non-directional fibers, for example glass fibers. Fibers of this type can be woven to form a framework, as a result of which an ordered fabric or also a nonwoven that is, at least in some areas, disordered, can be provided.

According to a particularly advantageous embodiment, the spark arrester is, at least in some areas, interwoven with a metallic wire. The metallic wire, which can have a higher thermal conductivity than a material surrounding it, allows the thermal energy to be dissipated from the stream of gas in a targeted or spatially limited manner along the spark arrester. In addition, the metallic wire gives the spark arrester an increased mechanical resistance, as a result of which, advantageously, kinetic energy of the particles and/or sparks of the stream of gas can be absorbed particularly effectively. As a result, for example, a mesh fabric made of the metallic wire may be provided, wherein, for example, the above-mentioned foamed material and/or at least in some areas a nonwoven composed of glass fibers may be arranged within the mesh.

A further embodiment provides that the spark arrester is arranged on a side of the cell housing and/or the battery housing facing away from the surroundings and/or facing the surroundings. In other words, the spark arrester can be arranged inside a respective housing or outside the housing or on both sides in relation to a respective housing wall. This has the advantage that the spark arrester can be arranged flexibly depending on the space available.

Preferably, the at least one degassing opening can be closed by a rupture element, it being possible for the rupture element to be designed, for example, as a rupture foil or rupture disc. This has the advantage that kinetic energy can be at least partly absorbed by the rupture element before the stream of gas hits the spark arrester.

The disclosure also relates to a motor vehicle having a battery system according to the disclosure.

The disclosure also includes further developments of the motor vehicle according to the disclosure having features as already described in connection with the further developments of the battery system according to the disclosure. For this reason, the corresponding developments of the motor vehicle according to the disclosure are not described once more.

The motor vehicle according to the disclosure is preferably configured as a car, especially as a passenger car or a truck, or as a passenger bus or motorcycle.

The disclosure also comprises combinations of the features of the embodiments described.

Exemplary embodiments of the disclosure are described below.

### BRIEF DESCRIPTION OF THE FIGURES

FIG. 1 shows a schematic detailed representation of an embodiment according to the disclosure of a battery cell having a degassing opening and a spark arrester within a battery housing; and

FIG. 2 shows a schematic representation of an embodiment according to the disclosure of a battery cell assembly within a battery system housing with oppositely arranged degassing openings.

### DETAILED DESCRIPTION

The exemplary embodiments explained below are preferred embodiments of the disclosure. In the exemplary embodiments, the components of the embodiments described each represent individual features of the disclosure which features are to be considered independently of one another and each of which further develops the disclosure independently. Therefore, the disclosure is intended to include combinations of the features of the embodiments other than those illustrated. Furthermore, the embodiments described can be supplemented by further features of the features of the disclosure already described.

In the figures, same reference numerals denote functionally identical elements.

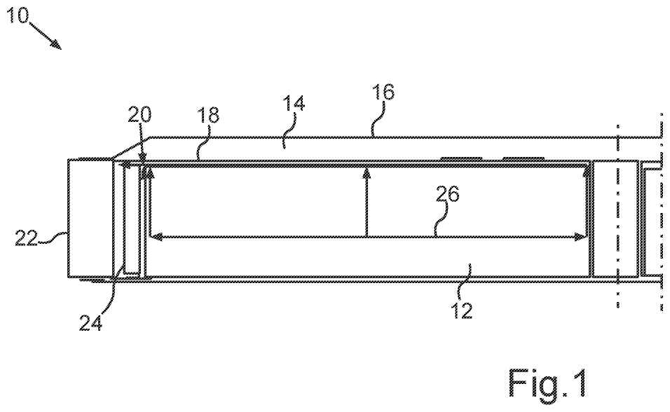

FIG. 1 shows a schematic cross-sectional illustration of a section of a battery system 10. The section of battery system 10 illustrated shows a battery cell 12, which is arranged in an interior 14 of a battery housing 16 of battery system 10. Battery cell 12 has a cell housing 18 with a degassing opening 20 being provided in cell housing 18. A spark arrester 24 is arranged between degassing opening 20 and a side sill 22.

If a galvanic cell, not illustrated in detail, of the battery cell 12 is outgassing or degassing, then a stream of gas can distribute along the degassing path illustrated by arrows 26 in FIG. 1. If a cell internal pressure increases as a result of said degassing, the gas can escape through degassing opening 20, wherein, after escaping, it passes through spark arrester 24 before entering interior 14 of battery housing 16. In the manner described, sparks and/or particles cannot only be filtered out from the stream of gas in spark arrester 24, but also a heat exchange can take place, which leads to a temperature of the stream of gas on entry into the interior 14 being below a predetermined limit temperature value.

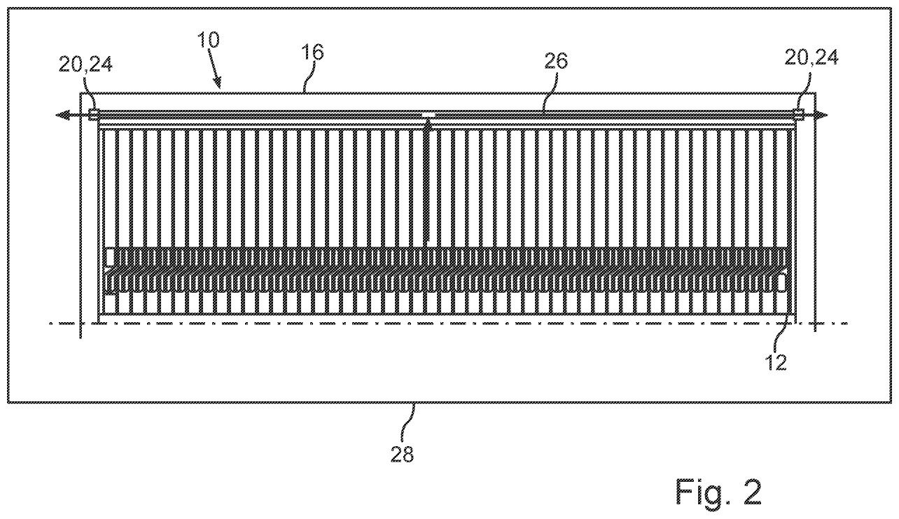

With reference to the components identified and described in connection with FIG. 1, FIG. 2 shows a motor vehicle 28 having a battery system 10. FIG. 2 shows a plurality of battery cells 12 which is arranged within battery housing 16 of battery system 10. For the sake of clarity, only battery cell 12 is provided with reference numerals on the far right. Furthermore, FIG. 2 illustrates schematically a degassing path 26 by means of arrows. When gas has escaped from one or more of battery cells 12, the gas that has escaped can spread or distribute or be directed along degassing path 26 within battery housing 16 of the battery system 10. FIG. 2 illustrates two degassing openings 20 of the battery housing 16 that are arranged at the edge and opposite each other. A spark arrester 24 may be arranged at each of degassing openings 20. Spark arresters 24 can, on the one hand, retain particles and/or sparks from the stream of gas in the manner described above, and on the other hand act as a heat exchanger to lower a temperature of the stream of gas below a predetermined limit temperature value, before the stream of gas escapes from battery housing 16.

In battery systems, a failure in a cell can result in a degassing of the cell. If the gas mixture is ignitable, there is a possibility of self-ignition in ambient air. For a gas mixture to ignite in principle, three essential circumstances must be present in accordance with the “fire triangle”: sufficient amount of fuel (reducer), sufficient amount of oxygen (oxidizer), sufficient ignition energy. As a result of outgassing there may be an ejection of glowing particles and/or sparks from a battery cell, which may be sufficient as ignition energy.

It is part of the present idea to separate the ignition sources (glowing particles and/or sparks) from the gas mixture before the gas mixture can mix with the air oxygen outside the battery. If the gas mixture cannot self-ignite because of its temperature, an ignition would not be possible according to the fire triangle in this case, because there is no ignition source.

The particle/spark arrester can at least in some areas comprise a meshed, gas permeable framework. The framework has two essential functions: it must be able to absorb the kinetic energy of the particles and/or sparks (mechanical brake) and it must be able to absorb the thermal energy of the particles and/or sparks (thermal barrier). Correspondingly, depending on the kinetic and/or thermal characteristics of the sparks and/or particles, the framework material must be mechanically and/or thermally resistant. Ceramic and/or glass-ceramic materials would be particularly suitable for this purpose. The framework may optionally be woven from glass fibers that form an ordered woven fabric and/or, at least in some areas, a disordered nonwoven fabric.

The Presented Degassing Concept Comprises 4 Levels:
degassing at cell level,
degassing at hybrid cell level (also: dual cell module or cell cassette),
degassing at battery system level, and
degassing from the battery system into the surroundings.

Degassing at Cell Level:

In the event of a failure within a pouch cell that leads to formation of gas in the cell, it is possible for the gas to escape from the cell. Theoretically, the position of the cell failure may be at any point within the cell coil within the (galvanic) cell. In the case of pouch cells, this outgassing usually takes place somewhere in the area of the weld seam. Depending on the mechanical mounting within a cell pack in a battery system, a pressure can be exerted on the cell, which has an influence on the gas opening of the cell.

Degassing at Hybrid Cell Level:

The outgassing of the pouch cell in the hybrid cell can take place along the weld seams. Starting from the lateral areas of the cell, the cell gas can flow in the steel housing of the hybrid cell up to the rupture area. After initiation or opening of the rupture opening, the cell gas may flow out of the housing of the hybrid cell.

Degassing at Battery System Level:

Within the battery system, the gas flows, via a beam element (e.g., an I-beam), from the hybrid cell into a gas duct, which can consist of steel at least in some areas. Within the gas duct there may be a material (preferably a woven fabric made of glass fibers) that can absorb sparks and/or particles which may arise during the outgassing of cells. This spark arrester can prevent a possible ignition of the cell gas outside the battery system. The space containing gas is separated from the electrical installation space in the battery system.

Degassing from the Battery System into the Surroundings:

At the battery system housing, the gas ducts may have rupture elements that are tripped when the pressure by the inflowing cell gas is sufficiently high. After the cell gas has flown into the degassing duct, it can be deflected and thus flow towards the rupture elements. The cell gas can reach the surroundings through the rupture elements.

In summary, the idea is based on a prevention of ignition energy. In order to achieve this task, the gas temperature must not be so high that self-ignition continues to be possible while mixing with the ambient air, despite the sparks and/or particles being filtered out. This can be set through the choice of the cell chemistry or through targeted heat extraction before entering ambient air.

Overall, the examples show how a spark arrester with a heat exchanger function can be provided for a high-voltage battery system.

1. A battery system, comprising: a plurality of battery cells arranged in a battery housing, wherein a respective battery cell has a cell housing at least partly surrounding a galvanic cell, wherein the cell housing and/or the battery housing have/has at least one degassing opening, which is designed to let a stream of gas escape from an interior of the cell housing and/or the battery housing along a predetermined degassing path into the surroundings of the battery cell and/or the battery system, wherein a spark arrester is arranged along the predetermined degassing path and designed to filter sparks and/or particles from the stream of gas, wherein the spark arrester is designed to reduce a flow rate of the stream of gas relative to an initial rate and to direct the stream of gas along a surface of the spark arrester, so that the stream of gas flows along the surface at least for a predetermined period of time, wherein the period of time, the surface, and the reduced flow rate are matched to one another such that thermal output energy is extracted from the stream of gas to the extent that a temperature of the stream of gas when escaping into the surroundings has dropped to a value below a predetermined limit temperature value.

2. The battery system according to claim 1, wherein the galvanic cell has an electrolyte having a predetermined chemical composition, wherein the predetermined limit temperature value is a function of at least one cell-chemical parameter of the chemical composition.

3. The battery system according to claim 1, wherein the spark arrester has a sponge structure with an open pore space, wherein the open pore space is designed to be traversed by the stream of gas.

4. The battery system according to claim 1, wherein the spark arrester has a fabric made of a glass fiber-based and/or ceramic material.

5. The battery system according to claim 1, wherein the spark arrester has directional and/or non-directional fibers.

6. The battery system according to claim 1, wherein the spark arrester is interwoven with a metallic wire.

7. The battery system according to claim 1, wherein the spark arrester is arranged on a side of the cell housing and/or the battery housing facing away from the surroundings and/or facing the surroundings.

8. The battery system according to claim 1, wherein the degassing opening can be closed by a rupture element.

9. The battery system according to claim 8, wherein the rupture element is designed as a rupture foil or rupture disk.

10. A motor vehicle having a battery system according to claim 1.

11. The battery system according to claim 2, wherein the spark arrester has a sponge structure with an open pore space, wherein the open pore space is designed to be traversed by the stream of gas.

12. The battery system according to claim 2, wherein the spark arrester has a fabric made of a glass fiber-based and/or ceramic material.

13. The battery system according to claim 3, wherein the spark arrester has a fabric made of a glass fiber-based and/or ceramic material.

14. The battery system according to claim 2, wherein the spark arrester has directional and/or non-directional fibers.

15. The battery system according to claim 3, wherein the spark arrester has directional and/or non-directional fibers.

16. The battery system according to claim 4, wherein the spark arrester has directional and/or non-directional fibers.

17. The battery system according to claim 2, wherein the spark arrester is interwoven with a metallic wire.

18. The battery system according to claim 3, wherein the spark arrester is interwoven with a metallic wire.

19. The battery system according to claim 4, wherein the spark arrester is interwoven with a metallic wire.

20. The battery system according to claim 5, wherein the spark arrester is interwoven with a metallic wire.
